(19) United States
(12) Patent Application Publication
(10) Pub. No.: US 2006/0263175 A1
(43) Pub. Date: Nov. 23, 2006

(54) Mechanical hand kit with remote control system

(75) Inventor: Ivan Gregory Yaeger, Miami, FL (US)

Correspondence Address: Ivan Yaeger, 230 N.E. 90th Street, Miami, FL, 33138, US

(73) Assignee: Y.I.P. Corporation, Miami, FL (US)

(21) Appl. No.: 11/431,498

(22) Filed: May 10, 2006

Related U.S. Application Data
(60) Provisional application No. 60/679,411, filed on May 11, 2005.

(51) Int. Cl. B25J 3/00

(52) U.S. Cl. 414/1

(57) ABSTRACT

The invention claimed herein presents a kit that allows the user to build a functioning model of the type of mechanical hand used in prosthetics and robotics. The finger segments 4 of each digit are connected in a fashion that results in adjustable joints. The completed hand opens and closes via motor and gearbox 8. (FIGS. 1 and 2). Limit switches 38 restrict travel of the fingers to the grip range of the human hand. The hand is operated using a electrical, radio, infrared or digital remote control system, with receiver 22 mounted in the hand and transmitter 28 concealed within a glove or cuff 30 which can be worn by the user (FIG. 2). This system allows the invention to be operated via motion of the user's hand/wrist 36, which actuates a switching means within said glove or cuff. Movement can also be activated via onboard control switch 24.

### CROSS-REFERENCE TO RELATED APPLICATIONS

This application is preceded by provisional patent 60/679,411 (filed May 11, 2005) which embodies the present design.

### STATEMENT REGARDING FEDERALLY SPONSORED RESEARCH OR DEVELOPMENT

Not Applicable

### REFERENCE TO SEQUENCE LISTING, A TABLE OR A COMPUTER LISTING COMPACT DISK APPENDIX

Not Applicable

### BACKGROUND OF THE INVENTION

This invention is related to robotic and prosthetic devices used for educational, entertainment, clinical and industrial purposes. Past inventions have demonstrated designs for mechanical hands configured to replicate the human hand. Most designs that are configured as a kit are designed for toy or hobby use do not present features such as a wearable control system or a multitude of adjustable joints that are presented in the claimed in this application.

### BRIEF SUMMARY OF THE INVENTION

The invention disclosed herein provides a product that can be provided as a kit of components which can be easily assembled and operated as a learning/recreational exercise. This kit can be incorporated in a classroom or home setting. It can also be used as a training device for patients who will be fitted with a prosthetic limb. Unique features include 1) choice of control systems; 2) limit switches to ensure realistic range of motion; 3) fully adjustable fingers and thumb; 4) ability to be easily customized by the user. One embodiment of the control system is a cuff that can be worn by the user that incorporates a radio control transmitter. This allows movements of the user's hand to produce movement of the mechanical hand.

### BRIEF DESCRIPTION OF THE SEVERAL VIEWS OF THE DRAWING

FIG. 1 shows a side view of the assembled device with remote control worn by user.

FIG. 2 shows a top view of the assembled device with a cutaway view of the wrist section.

### DETAILED DESCRIPTION OF THE INVENTION

This application pertains to a Mechanical Hand Kit with Remote Control System. It comprises a plurality of parts that form the various structural, actuation and control systems of the device. Gearbox 8 is attached to plate 2 via fastening means 6 as are brackets 10 on either side of said gearbox. Limit switches 12 are attached onto brackets 10 via fastening means 6. A second plate 2 is mounted onto the opposite side of gearbox 8. Each digit is constructed using three finger segments 4, which are formed from lengths of rigid material that are connected together at their ends via fastening means 6. Retainer wires 14 are attached between the first and third finger segments of each digit. Four complete digits are connected together with brackets 10 using fastening means 6; this unit is mounted onto the output shaft of gearbox. 8. Thumb comprises a similar assemblage of three finger segments, which are attached to second plate 2 via brackets 32. Brackets 32 are mounted via pivoting joint 34. The wrist is formed by wrist cylinder 16 and plug 18 which is mounted between plates 2 using fastening means 6. Battery pack 20 and remote control receiver 22 are mounted within wrist cylinder 16 or between plates 2. Onboard control switch 24 is mounted on wrist cap 26. Remote control transmitter 28 is mounted into control cuff 30; said cuff can be attached to a complete or partial glove (not shown). Remote control can be accomplished via radio/infrared signals or an electrical/fiber optic cable 34. Limit switches 38 are mounted in close proximity to the output shaft of gearbox 8. The hand can be easily adjusted to either a left-hand or right-hand configuration.

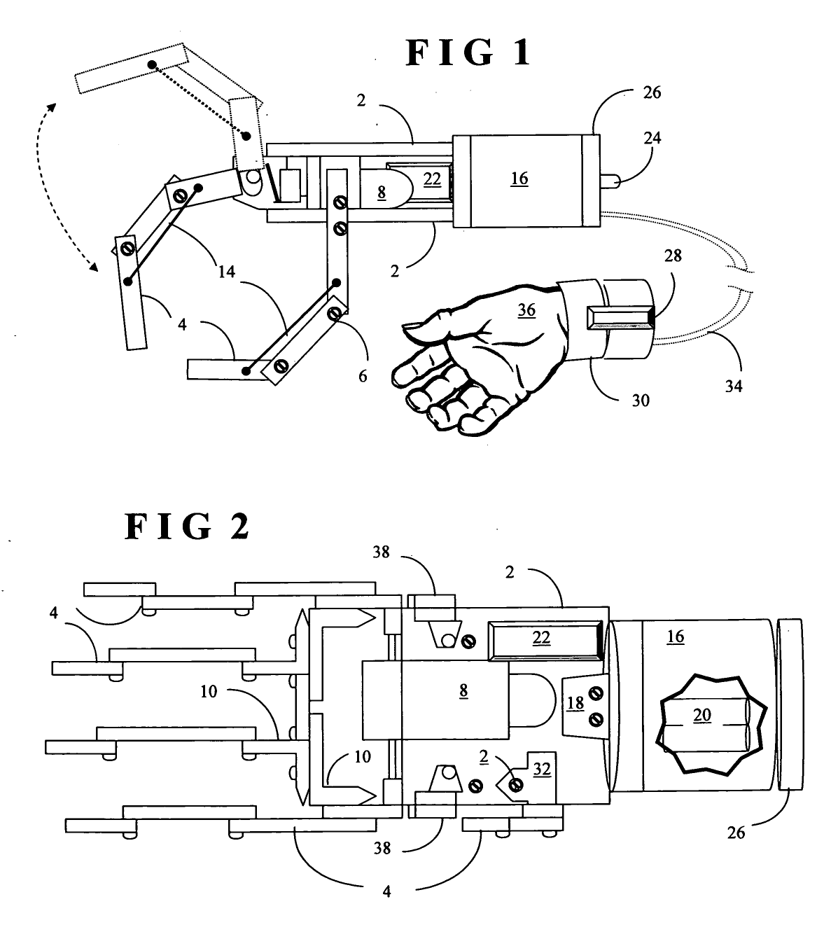

This kit allows the user to build a functioning life-sized model of the type of hand used in prosthetics and robotics. All components and easy-to-follow illustrated instructions are provided (FIG. 1). The finger segments of each digit are connected in a fashion which results in adjustable joints. Adjustment of said joints is limited by the tightness of the fasteners and by retainer wires spanning between the first and last finger segments. The completed bionic/robotic hand opens and closes at the touch of a switch and features adjustable fingers and thumb (FIGS. 2 and 3). Limit switches 38 restrict travel of the fingers to the grip range of the human hand. The bionic/robotic hand can be also being operated using a remote or radio control transmitted concealed within a glove which can be worn by the user (FIG. 2). This system allows the invention to be operated via flexion of the user's hand 36, which actuates a switching means within the glove. Movement can also be activated via onboard control switch 24.

The above description is for the purpose of teaching those skilled in the art how to practice the present invention and is not intended to recite all the possible modifications and variations thereof which will become apparent to the skilled worker upon reading. It is intended, however, that all such modifications and variations be included within the scope of the invention which is defined by the following claims.

I claim:

1) a kit that can be assembled into a remote-controlled mechanical hand, consisting of:
a) a plurality of finger units assembled from a plurality of rigid strips containing apertures at each end and featuring dimensions that correspond to the metacarpal segments of the human fingers, which are interconnected via a plurality of fasteners that correspond to said apertures and form joints between said rigid strips;
b) a thumb unit constructed from a plurality of rigid strips as used in the finger units that is attached upper plate via a bracket that presents a pivoting joint means which allows the thumb unit to replicate the rotational motion of the human thumb; and
c) a plurality of retainer wires that are affixed between the jointed sections of each finger and thumb unit via apertures at the ends of the aforementioned rigid strips, whereby said retainer wires fix the degree of finger curvature to the positions selected by the user;

2. A mechanical hand as described in claim 1 with addition of:
a) a motor and gearbox unit featuring an output shaft that extends in perpendicular orientation to the finger units;
b) a plurality of brackets that connect the individual finger units rigidly together and onto the terminal ends of the gearbox output shaft;
c) an upper housing and lower housing formed from a rigid material, featuring attachment means for mounting the motor and gearbox unit and thumb unit, as well as means for attaching said housings together; and
d) a plurality of limit switches mounted onto the inner face of the upper or lower housing whereby the brackets of the finger units actuate said switches at the extreme points of the finger motion.

3. A mechanical hand as described in claim 1 and 2 with addition of:
a) a wrist unit formed from a plug that is rigidly attached between the posterior ends of the upper and lower housing, a hollow cylindrical section that houses a battery pack and attaches to the plug's posterior end, and a removable cap which engages the posterior end of the cylinder;
b) a remote control receiver unit that is mounted between the upper and lower housings, featuring an electrical, radio frequency, infrared or digital control interface that completes the circuit with the aforementioned motor, limit switches and battery pack;
c) a remote control transmitter unit housed in a glove or cuff whereby motion of the user's wrist and hand generate electrical, radio, infrared or digital signals that actuate movement of the mechanical hand;
d) removable cap of the wrist unit featuring an electrical switch that acts as an alternate control means for the mechanical hand; and
e) removable cap of the wrist unit featuring an optional cable to interconnect an electrical signal-based remote control transmitter and receiver.
